(19) United States
(12) Patent Application Publication
(10) Pub. No.: US 2026/0172142 A1
(43) Pub. Date: Jun. 18, 2026

(54) METHODS AND APPARATUS FOR CORRELATED MULTIUSER CODING

(71) Applicant: Huawei Technologies Co., Ltd., Shenzhen (CN)

(72) Inventors: Nghia Trung Doan, Ottawa (CA); Huazi Zhang, Hangzhou (CN); Qifan Zhang, Kanata (CA); Yiqun Ge, Ottawa (CA)

(21) Appl. No.: 19/365,937

(22) Filed: Oct. 22, 2025

Related U.S. Application Data
(63) Continuation of application No. PCT/CN2023/090011, filed on Apr. 23, 2023.

(51) Int. Cl. H04L 1/00; H04W 72/23

(52) U.S. Cl. CPC H04L 1/005; H04W 72/23

(57) ABSTRACT

Systems and methods of employing distributed source coding in power-domain and/or code-domain uplink NOMA schemes are provided. In the provided systems and methods, the scheduling and the parameters of a joint source-channel coding and multiple access framework may be jointly optimized.

### CROSS-REFERENCE TO RELATED APPLICATION

The present application is a continuation of International Application No. PCT/CN2023/090011, entitled “METHODS AND APPARATUS FOR CORRELATED MULTIUSER CODING” and filed on Apr. 23, 2023, the disclosure of which is hereby incorporated by reference in its entirety.

### TECHNICAL FIELD

The application relates generally to wireless communications and more specifically to systems and methods for encoding data for transmission.

### BACKGROUND

Machine-Type Communication (MTC) is one of the scenarios that is supported by 5G and future wireless communication standards. The main design goal for MTC is to provide reliable and low-latency communication for a large number of Internet-of-Things (IoT) devices, user equipments (UE) in wireless terms, whose messages are often short and sparse. To fulfill the high spectrum efficiency requirement of MTC without incurring significant signaling overhead, which cannot be achieved by conventional Orthogonal Multiple Access (OMA) schemes, non-orthogonal multiple access (NOMA) schemes have been actively investigated and considered as a high potential candidate for 5G and beyond 5G standards.

In a NOMA scheme, different UEs are multiplexed through either power and/or code domain to communicate with the base station (BS), while sharing the same frequency band at the same time slot. In this NOMA multiplexing scheme, the data transmitted from different UEs are often recovered by the BS using interference cancellation decoding techniques, such as Successive Interference Cancellation (SIC), Parallel Interference Cancellation (PIC), or Turbo-Receiver iterative interference cancellation.

In the future, wireless communication systems may implement sensing by deploying a high density of sensor-UEs. All kinds of the sensors may be deployed everywhere to keep monitoring and sampling the physical surroundings. Accordingly, these sensor-UEs would keep sending data reflecting what they monitor to the network via wireless radio connections, which would present a huge overhead on the uplink of the wireless system. A very large number of small packages will be sent in the uplink simultaneously. Moreover, as these sensor-UEs will be connected via wireless connections, they will also keep sending their radio-channel related information to the network. Unlike traditional wireless communication, the future wireless would have to support a heavy uplink traffic that contains a great number of small simultaneous packages.

### SUMMARY

Systems and methods of employing distributed source coding in power-domain and/or code-domain uplink NOMA schemes are provided. Solutions in the present disclosure may take advantage of inherent and persistent spatial and temporal correlations among multiple sources. In the provided systems and methods, the scheduling and the parameters of a joint source-channel coding and multiple access framework may be jointly optimized. Through the use of distributed source coding assuming correlated sources, it may be possible to improve uplink spectrum efficiency compared to a system in which sources are uncorrelated, or an assumption is made that sources are uncorrelated, and distributed source coding is not employed.

According to one aspect of the present disclosure, there is provided a method in an apparatus, the method comprising: receiving signaling indicating a compressed payload size for use by the apparatus as part of a group of apparatuses having correlated data to transmit; transmitting a channel coded output, the channel coded output comprising an output of channel coding that has been applied to a payload that has been source coded using a polar code based on the compressed payload size and to which a cyclic redundancy check (CRC) for the source coded payload has been concatenated.

In some embodiments, transmitting the channel coded output comprises transmitting a power-domain non-orthogonal multiple access (NOMA) signal, the method further comprising: receiving signaling assigning a group ID to the apparatus, wherein the group ID is associated with the group of apparatuses with correlated data to transmit; receiving signaling indicating an apparatus specific gain adjustment; receiving signaling indicating a targeted group ID matching the group ID assigned to the apparatus, the signaling also indicating a group specific gain adjustment that is specific to apparatuses having the targeted group ID; transmitting the NOMA signal with a gain that is based on the apparatus specific gain adjustment, the group specific gain adjustment and a channel estimate.

In some embodiments, the method further comprises: receiving a first downlink control information (DCI) package, the first DCI being apparatus specific and comprising said signaling indicating the compressed payload size, said signaling assigning the group ID to the apparatus, and said signaling indicating the apparatus specific gain adjustment; receiving a second DCI package, the second DCI package being group specific and comprising said signaling indicating the targeted group ID matching the group ID assigned to the apparatus, and the group specific gain adjustment that is specific to apparatuses having the targeted group ID.

In some embodiments, transmitting the channel coded output comprises transmitting a code-domain NOMA signal, the method comprising: receiving signaling assigning a group ID to the apparatus, wherein the group ID is associated with the group of apparatuses with correlated data to transmit; receiving signaling indicating a targeted group ID and indicating payload adjustments for all UEs having the targeted group ID.

In some embodiments, the method further comprises: receiving a first DCI package, the first DCI being apparatus specific and comprising said signaling indicating the compressed payload size, said signaling assigning the group ID to the apparatus; receiving a second DCI package, the second DCI package being group specific and comprising said signaling indicating the targeted group ID matching the group ID assigned to the apparatus, and said signaling indicating payload adjustments for all apparatuses having the targeted group ID.

According to one aspect of the present disclosure, there is provided an apparatus comprising a processor and memory, the apparatus configured to perform a method comprising: receiving signaling indicating a compressed payload size for use by the apparatus as part of a group of apparatuses having correlated data to transmit; transmitting a channel coded output, the channel coded output comprising an output of channel coding that has been applied to a payload that has been source coded using a polar code based on the compressed payload size and to which a cyclic redundancy check (CRC) for the source coded payload has been concatenated.

In some embodiments, transmitting the channel coded output comprises transmitting a power-domain non-orthogonal multiple access (NOMA) signal, the method further comprising: receiving signaling assigning a group ID to the apparatus, wherein the group ID is associated with the group of apparatuses with correlated data to transmit; receiving signaling indicating an apparatus specific gain adjustment; receiving signaling indicating a targeted group ID matching the group ID assigned to the apparatus, the signaling also indicating a group specific gain adjustment that is specific to apparatuses having the targeted group ID; transmitting the NOMA signal with a gain that is based on the apparatus specific gain adjustment, the group specific gain adjustment and a channel estimate.

In some embodiments the method further comprises: receiving a first DCI package, the first DCI being apparatus specific and comprising said signaling indicating the compressed payload size, said signaling assigning the group ID to the apparatus, and said signaling indicating the apparatus specific gain adjustment; receiving a second DCI package, the second DCI package being group specific and comprising said signaling indicating the targeted group ID matching the group ID assigned to the apparatus, and the group specific gain adjustment that is specific to apparatuses having the targeted group ID.

In some embodiments, transmitting the channel coded output comprises transmitting a code-domain NOMA signal, the method further comprising: receiving signaling assigning a group ID to the apparatus, wherein the group ID is associated with the group of apparatuses with correlated data to transmit; receiving signaling indicating a targeted group ID and indicating payload adjustments for all UEs having the targeted group ID.

In some embodiments, the method further comprising: receiving a first DCI package, the first DCI being apparatus specific and comprising said signaling indicating the compressed payload size, said signaling assigning the group ID to the apparatus; receiving a second DCI package, the second DCI package being group specific and comprising said signaling indicating the targeted group ID matching the group ID assigned to the apparatus, and said signaling indicating payload adjustments for all apparatuses having the targeted group ID.

According to a further aspect of the present disclosure, there is provided a method in a base station, the method comprising: transmitting signaling indicating a compressed payload size for use by the apparatus as part of a group of apparatus having correlated data to transmit; receiving a channel coded output, the channel coded output comprising an output of channel coding that has been applied to a payload that has been source coded using a polar code based on the compressed payload size and to which a cyclic redundancy check (CRC) for the source coded payload has been concatenated.

In some embodiments, receiving the channel coded output comprises receiving a power-domain non-orthogonal multiple access (NOMA) signal, the method further comprising: transmitting signaling assigning a group ID to the apparatus, wherein the group ID is associated with the group of apparatuses with correlated data to transmit; transmitting signaling indicating an apparatus specific gain adjustment; transmitting signaling indicating a targeted group ID matching the group ID assigned to the apparatus, the signaling also indicating a group specific gain adjustment that is specific to apparatuses having the targeted group ID; receiving the NOMA signal with a gain that is based on the apparatus specific gain adjustment, the group specific gain adjustment and a channel estimate.

In some embodiments, the method comprises: transmitting a first DCI package, the first DCI being apparatus specific and comprising said signaling indicating the compressed payload size, said signaling assigning the group ID to the apparatus, and said signaling indicating the apparatus specific gain adjustment; transmitting a second DCI package, the second DCI package being group specific and comprising said signaling indicating the targeted group ID matching the group ID assigned to the apparatus, and the group specific gain adjustment that is specific to apparatuses having the targeted group ID.

In some embodiments, receiving the channel coded output comprises transmitting a code-domain NOMA signal, the method further comprising: transmitting signaling assigning a group ID to the apparatus, wherein the group ID is associated with the group of apparatuses with correlated data to transmit; transmitting signaling indicating a targeted group ID and indicating payload adjustments for all UEs having the targeted group ID.

In some embodiments, the method comprises: transmitting a first DCI package, the first DCI being apparatus specific and comprising said signaling indicating the compressed payload size, said signaling assigning the group ID to the apparatus; transmitting a second DCI package, the second DCI package being group specific and comprising said signaling indicating the targeted group ID matching the group ID assigned to the apparatus, and said signaling indicating payload adjustments for all apparatuses having the targeted group ID.

According to yet another aspect of the present disclosure, there is provided a network device comprising a processor and memory, the network device configured to perform a method comprising: transmitting signaling indicating a compressed payload size for use by the apparatus as part of a group of apparatus having correlated data to transmit; receiving a channel coded output, the channel coded output comprising an output of channel coding that has been applied to a payload that has been source coded using a polar code based on the compressed payload size and to which a cyclic redundancy check (CRC) for the source coded payload has been concatenated.

In some embodiments, receiving the channel coded output comprises receiving a power-domain non-orthogonal multiple access (NOMA) signal, the method further comprising: transmitting signaling assigning a group ID to the apparatus, wherein the group ID is associated with the group of apparatuses with correlated data to transmit; transmitting signaling indicating an apparatus specific gain adjustment; transmitting signaling indicating a targeted group ID matching the group ID assigned to the apparatus, the signaling also indicating a group specific gain adjustment that is specific to apparatuses having the targeted group ID; receiving the NOMA signal with a gain that is based on the apparatus specific gain adjustment, the group specific gain adjustment and a channel estimate.

In some embodiments, the method further comprises: transmitting a first DCI package, the first DCI being apparatus specific and comprising said signaling indicating the compressed payload size, said signaling assigning the group ID to the apparatus, and said signaling indicating the apparatus specific gain adjustment; transmitting a second DCI package, the second DCI package being group specific and comprising said signaling indicating the targeted group ID matching the group ID assigned to the apparatus, and the group specific gain adjustment that is specific to apparatuses having the targeted group ID.

In some embodiments, receiving the channel coded output comprises transmitting a code-domain NOMA signal, the method further comprising: transmitting signaling assigning a group ID to the apparatus, wherein the group ID is associated with the group of apparatuses with correlated data to transmit; transmitting signaling indicating a targeted group ID and indicating payload adjustments for all UEs having the targeted group ID.

In some embodiments, the method further comprises: transmitting a first DCI package, the first DCI being apparatus specific and comprising said signaling indicating the compressed payload size, said signaling assigning the group ID to the apparatus; transmitting a second DCI package, the second DCI package being group specific and comprising said signaling indicating the targeted group ID matching the group ID assigned to the apparatus, and said signaling indicating payload adjustments for all apparatuses having the targeted group ID.

### BRIEF DESCRIPTION OF THE DRAWINGS

Embodiments of the disclosure will now be described with reference to the attached drawings in which:

FIG. 1 is a block diagram of a communication system;

FIG. 2 is a block diagram of a communication system;

FIG. 3 is a block diagram of a communication system showing a basic component structure of an electronic device (ED) and a base station;

FIG. 4 is a block diagram of modules that may be used to implement or perform one or more of the steps of embodiments of the application;

FIG. 5A depicts a framework for a system with joint source-channel coding and multiple access;

FIG. 5B is a diagram showing an example of rate allocation;

FIGS. 6A and 6B shows block diagrams of uplink communication between 4 correlated UEs and a BS;

FIG. 7 is a block diagram showing a method of user grouping, payload size determination and determining source decoding order;

FIG. 8 is a block diagram of an example of cyclic redundancy check (CRC) attachment;

FIG. 9 is a block diagram of an example of source decoding;

FIG. 10 is an overview of signaling from the BS to UE to support the provided transmission from correlated UEs;

FIGS. 11A, 11B and 11C contain plots of example performance results.

### DETAILED DESCRIPTION

A major problem associated with the existing NOMA schemes is that an assumption is made that the transmission data of the UEs are completely independent, hence ignoring the case in which data correlations exist among the UEs. This leaves less room for the multiple access code design space, resulting in limited NOMA performance gain in practice. In various practical applications when the UEs are deployed spatially close to each other, correlations among the UEs are inevitably present. For instance, in dense camera sensor networks where each UE is associated with a surveillance camera, the viewpoint of a camera is often overlapped with those of the other cameras. This leads to data correlations, spatially and temporally, among the UEs. When each UE in this application is tasked with capturing a time-series signal, such as a series of video frames, and then sending them to the BS, the time-series signals from some close UEs may be spatially correlated to each other.

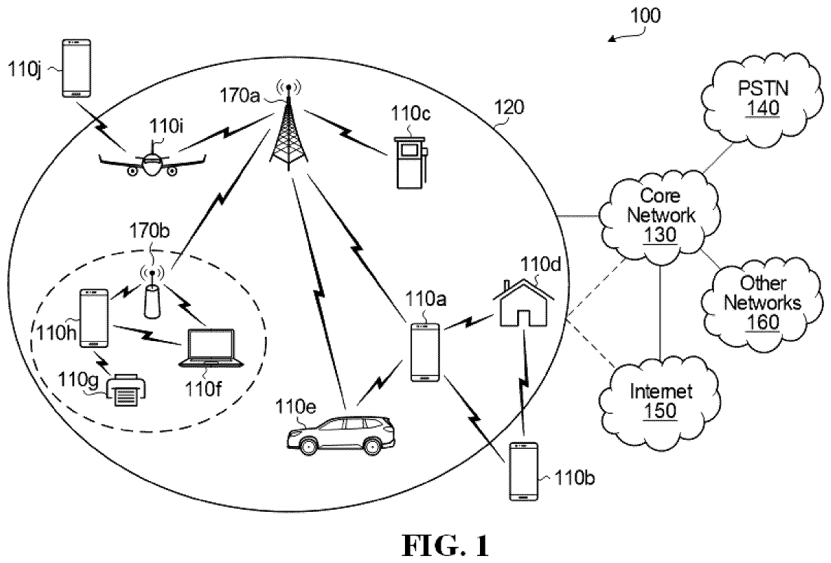

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

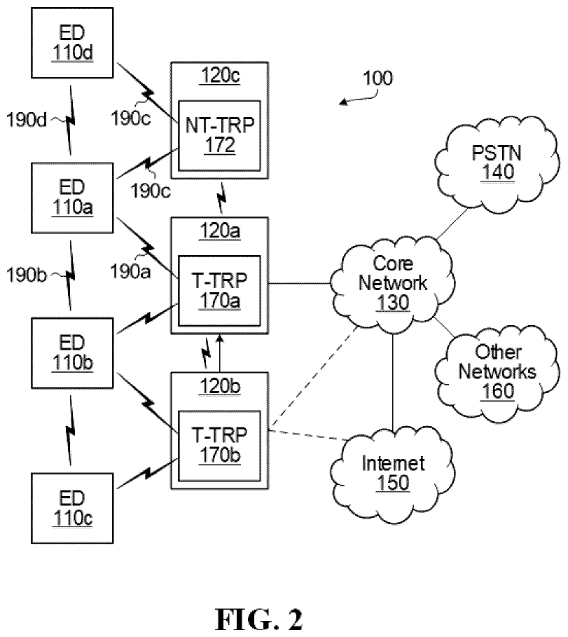

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and nod may also communicate directly with one another via one or more sidelink air interfaces 190b. In some examples, ED nod may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED nod and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130 and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some, or all, of the EDs noa 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies and may incorporate multiple transceivers necessary to support such operation.

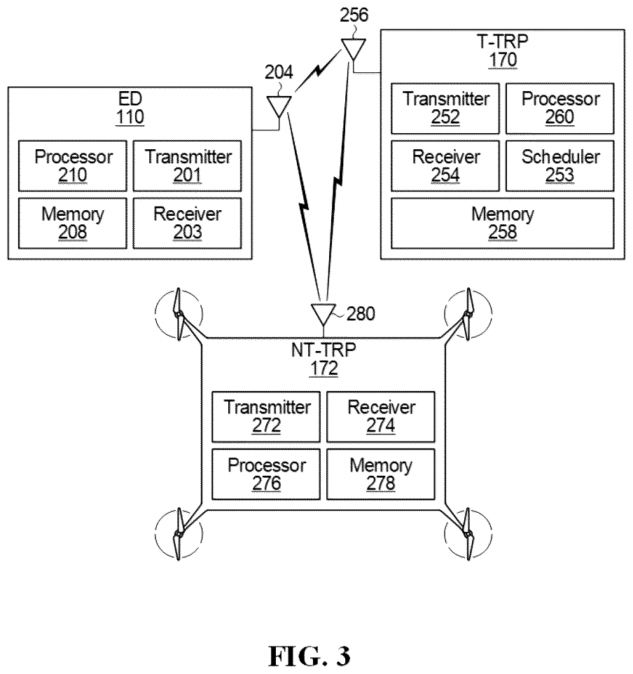

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the foregoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random-access memory (RAM), read-only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a terrestrial node, a terrestrial network device, a terrestrial base station, base band unit (BBU), remote radio unit (RRU), active antenna unit (AAU), remote radio head (RRH), central unit (CU), distributed unit (DU), positioning node, among other possibilities. The T-TRP 170 may be macro BSs, pico BSs, relay node, donor node, or the like, or combinations thereof. The T-TRP 170 may refer to the forgoing devices or apparatus (e.g. communication module, modem, or chip) in the forgoing devices

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

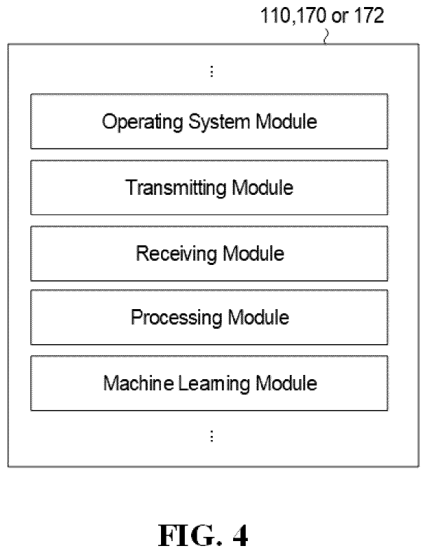

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor, for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

Systems and methods of employing distributed source coding in power-domain and/or code-domain uplink NOMA schemes are provided. These systems and methods may take advantage of inherent and persistent spatial and temporal correlations among multiple sources. In the provided systems and methods, the scheduling and the parameters of a joint source-channel coding and multiple access framework may be jointly optimized. Through the use of distributed source coding assuming correlated sources, it may be possible to improve uplink spectrum efficiency compared to a system in which sources are uncorrelated, or an assumption is made that sources are uncorrelated, and distributed source coding is not employed.

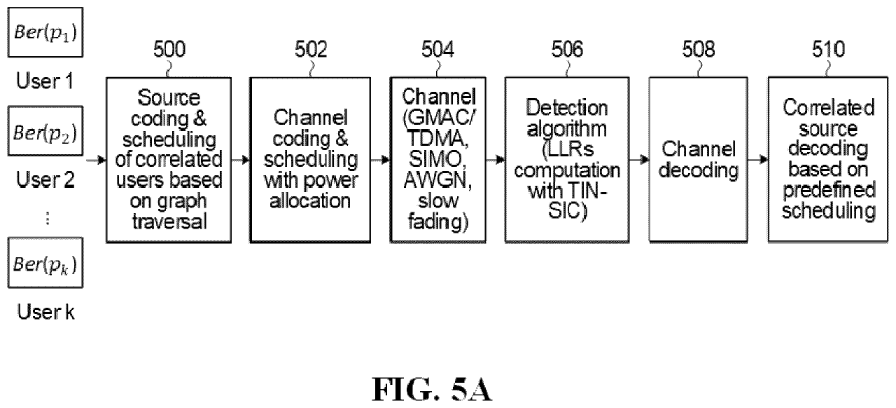

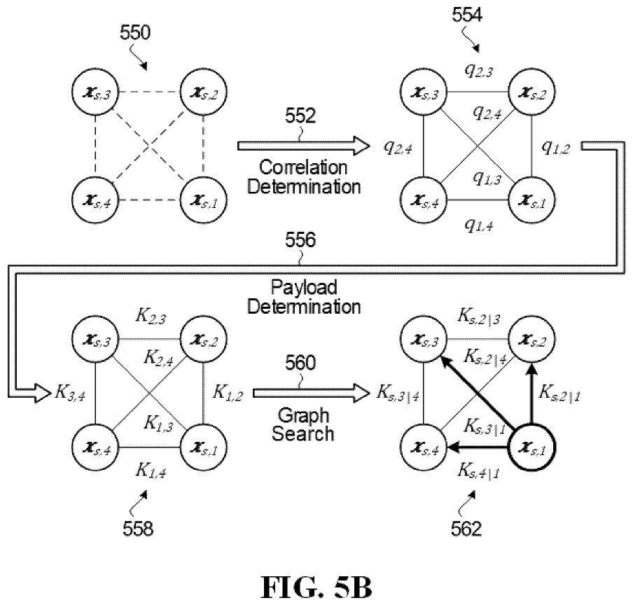

An overview of the provided joint source-channel coding and multiple access framework will be described with reference to FIG. 5A. Details of each of the elements shown in FIG. 5A are provided below. At 500, source coding and scheduling of correlated users based on graph traversal is performed. Scheduling is performed at the network side, for example, in a base station. Scheduling here refers to identifying groups of UEs that are correlated and that will be treated together, and determining a source decoding order that takes into account the manner of source coding applied in the UEs. At 502, channel coding is performed. This may include power allocation in the case of power-domain non-orthogonal multiple access (NOMA). The power allocation is tied to the channel decoding order in the receiver. Transmission over a channel is depicted logically at 504. The provided framework is applicable to a wide variety of channel types. Detecting the transmitted signal using detection algorithms is indicated at 506. This can involve, for example, log-likelihood ratio (LLR) computation with treating interference as noise and successive interference cancellation (TIN-SIC). Channel decoding takes place at 508 based on the determined channel decoding order. Correlated source decoding based on the determined source decoding order takes place at 510. The channel decoding order and the source decoding order can be different.

At the receiver, an iterative Turbo-like receiver with successive interference cancellation (SIC) may be employed. With this approach, it is assumed that at the final decoding attempt of a UE's data transmission, the interferences of all the other UEs' transmissions are completely canceled. This assumption allows for a fixed channel decoding scheduling that is SNR independent, as long as the source correlation modelling remains the same. For power-domain NOMA, a low-complexity power allocation scheme is applied on top of the fixed channel decoding scheduling that broadcasts a single parameter to all the UEs of a targeted group. For code-domain NOMA, the channel code rate of each UE is modified and broadcasted to a targeted group. The modified code rates simulate a near-far relationship between all pairs of the UEs that are successive in a predefined channel decoding order.

### Rate Allocation and Source Decoding Order

Rate allocation involves determining a respective reduced payload for each of a set of correlated data sources. This is referred to as rate allocation, as reducing the payload sizes of correlated users results in smaller code-rates seen from the channel coding point of view. As detailed below, Polar coding is applied to compress payload size of a given data source to a reduced payload size. The source decoding order is the order of source decoding in the base station. The rate allocation and source decoding order are related. It is noted that an input to the provided systems and methods is a set of correlated users. This can, for example, be obtained from a topological search run by the BS, though other methods may also be suitable.

Correlated sources can be described as follows. Given k correlated binary sources of length Nₛ, denoted as x_{s,i}, 1≤i≤k, the data correlation of the i-th and j-th sources, 1≤j≤k, i≠j, is described by the parameters 0≤q_{i,j}=q_{j,i}≤1 such that the correlation vectors t_{i,j}=t_{j,i}=x_{s,i}⊕x_{s,j} are drawn from a Bernoulli distribution with probability q_{i,j}=q_{j,i}. The i-th binary source x_{s,i} is associated with the i-th UE.

A method of rate allocation will be described with reference to FIG. 5B, which shows a specific case where there are four correlated sources. A fully-connected graph is formed that indicates all the pair-wise source correlations. An example of the fully-connected graph for the case of four sources is shown in FIG. 5B at 550. At 552, the source correlation parameter q_{i,j}=q_{j,i} of the i-th and the j-th UEs is first obtained. The correlation between pairs of sources can be determined using any suitable method. In some embodiments, the correlations are previously known and are input to the method. In a specific example, the correlations are obtained from the previous observations of the binary sources, which can be used to estimate the correlations as follows:

$${q}_{i , j} = {q}_{j , i} \approx \frac{1}{{N}_{s}} {\sum }_{n = 1}^{{N}_{s}} \vert {x}_{s , i} [ n ] - {x}_{s , j} [ n ] \vert ,$$

where x_{s,i} and x_{s,j} are the previous observations of the binary sources, and x_{s,i}[n] is the n-th bit of x_{s,i}(1≤n≤Nₛ). The example graph updated to include the correlations is shown at 554. Then, the edges of the graph connecting the UEs with indices i and j are pruned if q_{i,j}≥0.5−Δ, 0≤Δ<<0.5. This condition indicates that the correlation between the two UEs are weak, hence the graph edge associated with this correlation can be removed. Other criteria or thresholds for removal of a graph edge may alternatively be employed, this being merely an example. Removing a graph edge has the effect of excluding that graph from inclusion in the graph traversal described below. In the example of FIG. 5B, no graph edges have been removed. It is noted that if no edge pruning is performed, the complexity of the graph search will be increased. Depending on the number of edges, and the processing capability of the base station, it may be appropriate in some circumstances to omit the edge pruning step.

Given q_{i,j}, the reduced payload K_{i,j}=K_{j,i} is then obtained as

$${K}_{i , j} = {K}_{j , i} = min \{ α {N}_{s} H ( {q}_{i , j} ) , {N}_{s} \} ,$$

Nₛ is the original payload size;
where K_{i,j} is the reduced payload size required by the i-th user to reconstruct its original payload when the payload of the j-th reference UE is known and vice versa;
where H(q_{i,j})=−q_{i,j} log₂ q_{i,j}−(1−q_{i,j})log₂(1−q_{i,j}) is the binary cross entropy function, and α, α≥1, is a scaling factor indicating the minimum payload when a small value of Nₛ is considered. Intuitively, a controls how much a correlated source is compressed.

In FIG. 5B, payload determination is indicated at 556, and the graph updated to include the reduced payloads is shown at 558.

Next, a graph traversal algorithm, also referred to as a graph search, is run on top of the graph to find a graph traversal sequence that visits all the nodes while minimizing the sum of K_{i,j}<Nₛ∀i≠j. Thus, it can be observed that the graph search algorithm tries to minimize the overall system's payload. In addition, the graph search algorithm also outputs the source decoding dependency based on the relation of the reference and distributed sources. For instance, the reference UE with index j must be decoded before the distributed UE with index i is decoded.

Given the outputs of the graph search algorithm, the BS then assigns the new payload sizes for all the correlated sources as K_{s,i}=K_{s,i|j}<Nₛ. K_{s,i|j} is understood as the reduced payload size of the i-th user, whose original payload can be computed using the reference j-th user. The K_{s,i|j} notation also indicates the source decoding order between the j-th and the i-th users, where the original payload of the j-th reference user must be first obtained prior to that of the i-th correlated user. Note that the payload size remains as Nₛ for any UEs that are selected as the reference source.

In FIG. 5B, the graph search step is indicated at 560, and the graph updated to include the result is shown at 562, including the new payload sizes.

The output of graph traversal also indicates a source decoding order. In the example of FIG. 5B, after the graph traversal, the following source decoding order is obtained:

$$\{ \begin{matrix}{x}_{s , 1} \to {x}_{s , 2 ,} \\ {x}_{s , 1} \to {x}_{s , 3 ,} \\ {x}_{s , 1} \to {x}_{s , 4.}\end{matrix}$$

Specifically, x_{s,1} acts as the reference source that will be used to decode the other sources. As a result, x_{s,1} must be first computed before performing correlated source decoding to obtain x_{s,2}, x_{s,3}, and x_{s,4}. The new payloads are {K_{s,1}=Nₛ, K_{s,2}=K_{s,2|1}, K_{s,3}=K_{s,3|1}, K_{s,4}=K_{s,4|1}}. If source correlation is not considered, each source needs to send Nₛ bits.

For a given source that has a payload size<Nₛ bits, source coding is performed to produce a compressed payload.

To further improve the source block error rate (BLER) performance under CRC-aided successive cancellation list (CA-SCL) decoding, at the distributed UEs, CRC bits of the binary source x_{s,i} can optionally be computed and concatenated with the compressed payload. C_{s,i} is used to denote the CRC length of the i-th distributed source. C_{s,i} may be determined based on the original payload size Nₛ using a Modulation Coding Scheme (MCS) table that is both known by the UEs and the BS.

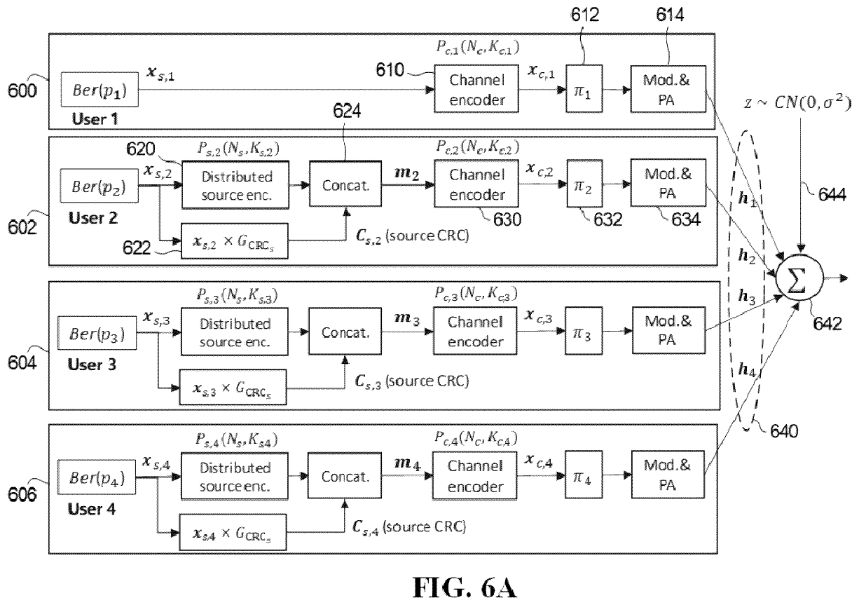

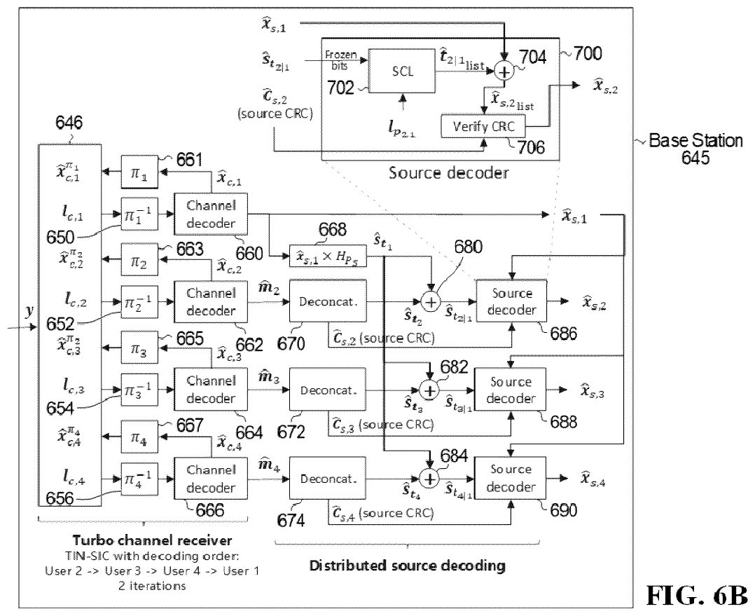

FIGS. 6A and 6B show example system block diagrams, with UE-side functionality depicted in FIG. 6A, and base station-side functionality in FIG. 6B. The diagram includes UEs configured to perform source coding and computation and concatenation of CRC using the described rate allocation. In FIG. 6A, UE1 600 is assumed to be a reference UE, meaning its data is not compressed or source coded. UE2 602, UE3 604 and UE4 606 are all subject to source coding, and are also referred to as dependent UEs. In a practical implementation, any UE may be configurable to function as a reference UE or a dependent UE.

For UE1 600, and more generally for any UE functioning as a reference UE, there is no source coding (or source coding is turned off or bypassed). Channel encoding takes place at 610, followed by bit interleaving at 612 and modulation at 614. In some embodiments, the power of the modulated signals may be adjusted using a precomputed power scale parameter, for example, as described below in the discussion of power allocation. The transmit chain for UE1 600, and more generally for a source UE, may include other functions not shown.

For UE2 602, and more generally for any UE functioning as a dependent UE such as UE3 604 and UE4 606, shown is distributed source encoder 620 which performs source coding on the payload for UE2. A CRC is computed at 622, and the computed CRC is concatenated with the output of source coding at 624. The output is subject to channel encoding in channel encoder 630, bit interleaving in 632, and modulation at 634. Of course, the transmit chain for UE2 602, and more generally for a dependent UE may include other functions not shown.

The UEs of FIG. 6A use configurations previously provided by the BS, for example through downlink control information (DCI) packages, as detailed below. At the correlated UEs with indices i∈{2; 3; 4}, the source coding codes are indicated as P_{s,i}(Nₛ, K_{s,i}), while the channel encoding codes are indicated as P_{c,i}(N_{c}, K_{c,i}). πᵢ indicates a bit interleaving operation that is known by both the UEs and the BS. As noted above, there is no source coding change made to the encoding process of the reference UE1.

Also shown in FIG. 6A is the effect of transmission over a transmission channel, where the simultaneous transmissions add together as indicated symbolically at 642. The effect of the channel on each transmission is given by h₁, . . . , h₄ as indicated at 640. An additive noise component is also shown at 644.

Basestation Processing for Transmissions from Correlated Sources

Methods of receiver processing of transmissions from corelated sources are provided. These can involve, for example defining the decoding scheduling and defining some network parameters used by the channel decoding task. The network parameters may include, for example, parameters related to the correlated users being under either a power-domain or a code-domain NOMA scheme. The following steps are common for both the power-domain and code-domain NOMA schemes.

In the example of a Turbo-like receiver being used at the BS for the channel decoding task, it is assumed that interference is successfully canceled at the final decoding attempt of each user. Thus, the instantaneous E_{b}/N₀ values for all the users are computed and then ranked from high to low, indicating the initial (natural) decoding order from strong to weak users.

A channel decoding order without fading effect and power allocation can be determined according to

$$\{ \frac{{E}_{{b}_{1}}}{{N}_{0}} , \frac{{E}_{{b}_{2}}}{{N}_{0}} , ... , \frac{{E}_{{b}_{k}}}{{N}_{0}} \} = \{ \frac{{E}_{s} / {N}_{0}}{{r}_{1} {log}_{2} M} , \frac{{E}_{s} / {N}_{0}}{{r}_{2} {log}_{2} M} , ... , \frac{{E}_{s} / {N}_{0}}{{r}_{K} {log}_{2} M} \} ,$$

where E_{b}_{₁}≥E_{b}_{₂}≥ . . . ≥E_{b}_{ₖ}, rᵢ is the code rate of the i-th user and M is the number of modulation symbols.

A predefined virtual “power gain” g for all adjacent UEs in the initial decoding order is imposed such that

$$\frac{{E}_{{b}_{i}}}{{N}_{0}} = {g}_{i} \frac{{E}_{{b}_{i + 1}}}{{N}_{0}} ,$$

∀i<k, and gᵢ>1. This is to introduce a virtual near-far effect to benefit the SIC-based decoding process. gᵢ is empirically selected for each pair of UEs following the initial decoding order as:

$${g}_{i} = \{ \begin{matrix}1.5 & if {t}_{i} \leq 1.5 , \\ 1.8 & if {t}_{i} \leq 1.8 , \\ {t}_{i} & otherwise ,\end{matrix}$$

where

$${t}_{i} = \frac{{E}_{{b}_{i}} / {N}_{0}}{{E}_{{b}_{i + 1} / {N}_{0}}} = \frac{{r}_{i + 1}}{{r}_{i}} \geq 1.$$

The operations described in the next step are first described for power-domain NOMA. After gᵢ is imposed, let the corresponding power gains of users i-th and (i+1)-th are aᵢ and aᵢ₊₁, respectively. The following constraints apply:

$$\frac{{a}_{i}^{2} / {r}_{i}}{{a}_{i + 1}^{2} / {r}_{i + 1}} = {g}_{i} , ∀ i < k , and {a}_{k} = 1 ,$$

and the general power constrain

$${\sum }_{i = 1}^{k} {( {a}_{i} {E}_{s} )}^{2} = {k ( {E}_{s} )}^{2} = k , {a}_{i} > 0 ∀ i .$$

Note that the power gains aᵢ are SNR irrelevant. Using substitution to solve for aᵢ gives

$${a}_{1} = \frac{\sqrt{k}}{\sqrt{1 + {\sum }_{i = 2}^{k} \frac{{\prod }_{j = 2}^{i} {t}_{j}^{2}}{{\prod }_{j = 2}^{i} {g}_{j}^{2}}}} ; {a}_{2} = \sqrt{\frac{{a}_{1}^{2} {t}_{2}}{{g}_{2}}} ; ... ; {a}_{i + 1} = \sqrt{\frac{{a}_{i}^{2} {t}_{i + 1}}{{g}_{i + 1}}} ; ... ; \\ and {a}_{k} = 1.$$

The fixed power gain aᵢ is then sent to the i-th UE. In case of fading with channel gain hᵢ, the i-th user then computes the power gain

$${a}_{i}^{′}$$

that accounts for the fading effect, given aᵢ and an adjusted power scaling factor β, as

$${a}_{i}^{′} = \frac{{a}_{i}}{β \vert {h}_{i} \vert} , where β = \sqrt{\frac{{\sum }_{i = 1}^{k} \frac{{a}_{i}^{2}}{{\vert {h}_{i} \vert}^{2}}}{{\sum }_{i = 1}^{k} {a}_{i}^{2}}} = \sqrt{\frac{1}{k} {\sum }_{i = 1}^{k} \frac{{a}_{i}^{2}}{{\vert {h}_{i} \vert}^{2}}} .$$

In case of multiple receive antennas,

$$\vert {h}_{i} \vert = \sqrt{{\sum }_{p = 1}^{RX} {\vert {h}_{i , p} \vert}^{2}} ,$$

where RX is the number of receive antennas at the base station and h_{i,p} is the channel gain between the transmit antenna of the i-th UE and the p-th receive antenna of the BS. The adjusted power factor β guarantees that the total power constrain condition is preserved for aᵢ′, i.e.,

$${\sum }_{i = 1}^{k} {( {a}_{i}^{′} )}^{2} = k .$$

Note that the computation of β for a new estimate of h is of low complexity. The adjusted power gain is applied to modulated symbols in the transmitter, for example in block 614 of FIG. 6A.

The operations for the next step for code-domain NOMA will now be described. After gᵢ is imposed, the payload size is recomputed to improve SIC-based decoding as

$${K}_{s , i + 1} = min ( {g}_{i} {K}_{s , i} , {N}_{s} ) , 1 < i \leq k - 1.$$

It is empirically observed that the provided power-domain NOMA scheme performs better than the provided code-domain NOMA scheme. However, this improvement comes at the cost of a more complex receiver as accurate channel estimation at the BS is required for power-domain NOMA to perform well.

Turning now to FIG. 6B, shown is an example of functionality at the receiver side, for example, in a base station 645, for processing the transmissions. This functionality again assumes UE1 to be a reference source, and there to be other dependent sources, but the receiver is generally adaptable to any UE functioning as the reference source, and differing numbers of dependent sources.

At the BS 645, a two-iteration Turbo channel receiver with SIC is used to demultiplex the UEs' data, followed by the distributed source decoding step with the predefined scheduling as described with reference to FIG. 5A. In FIG. 6B, the detailed block diagram of the source CA-SCL decoder is also illustrated. At the UEs, a single polar encoder is used for both the source and channel encoding task and a CA-SCL decoder is used for both the source and channel decoding task at the BS.

In a specific implementation, the following steps are performed in the receiver. In LLR computation block 646, obtain L_{c,i} which is the channel LLR vector associated with the i-th UE. In blocks 650,652,654,656 perform de-interleaving. In blocks 660, 662,664,666 perform channel decoding. \hat{m}ᵢ is the channel decoding output of the i-th user. In block 668, compute an estimate ŝ_{t,1} of the estimate compressed payload of the binary source x_{s,1}, where Hₚ_{ₛ} is the parity-check matrix of the source polar code according to \hat{x}_{s,1}×Hₚ_{ₛ}=ŝ_{t,1}. The LLR computation block 646, de-interleavers 650,652,654,656, channel decoders 660,662,664,666 and interleavers 661,663,665,667 (used to feed back estimates for interference cancellation as described below) collectively form a Turbo channel receiver. The remaining blocks to the right perform distributed source decoding. In deconcatenation blocks 670,672,674, compute an estimate of the compressed payload of the binary source x_{s,2}. ŝ_{t,2} (and similarly ŝ_{t,3}, and ŝ_{t,4}). This involves deconcatenating the estimated CRC from the estimated compressed payload. In combiners 680,682,684, determine the syndrome of the estimate correlation vector between x_{s,1} and x_{s,2} according to:

$${\hat{s}}_{t , 2} ⊕ {\hat{s}}_{t , 1} = ( {\hat{x}}_{s , 1} ⊕ {\hat{x}}_{s , 2} ) \times {H}_{{P}_{s}} = {\hat{t}}_{2 \vert 1} \times {H}_{{P}_{s}} = {\hat{s}}_{t , 2 \vert 1}$$

where the symbol ⊕ indicates a modulo 2 addition (i.e., XOR) operation. Perform source decoding in blocks 686,688,690. The functionality of one source decoder is expanded at 700. Inside the source decoder 700, l_{P2,1} is the LLR vector used by polar source decoding obtained from the correlation parameter P_{2,1} (already available and was used in the graph search). ŝ_{t,2|1} and l_{P2,1} are then used as inputs to the source successive cancellation list (SCL) decoder 702 to obtain a list of the estimated correlation vector \hat{t}_{2|1}, indicated as \hat{t}_{2|1}_{_{List}}, Each vector element of \hat{t}_{2|1}_{_{List}} is then XOR-ed with \hat{x}_{s,1} at 704 to form a list of the estimates for binary source \hat{x}_{s,1}_{_{List}}. Then, the provided source CRC verification scheme is used at 706 to select the \hat{x}_{s,2} vector from \hat{x}_{s,2}_{_{List}}. Specifically, the CRC bits are computed for each binary vector in \hat{x}_{s,2}_{_{List}}, \hat{x}_{s,2} is selected as the final output from \hat{t}_{2|1}_{_{List}}if its source CRC bits are similar to Ĉ_{s,2}, which denotes the estimate CRC bits of \hat{x}_{s,2} obtained from channel decoding.

The following is an example of how the Turbo channel receiver might function, where two iterations are performed. In the first iteration, successive inference cancellation (SIC) is used.

Given the predetermined channel decoding order: UE2→UE3→UE4→UE1, at the first iteration, the LLR computation block 646 first computes l_{c,2} (LLR values of UE2) directly using y by treating the interference of all the other users as noise (this is possible as UE2's signals are the strongest). The channel decoder 662 for UE2's signal then estimates the coded bits \hat{x}_{c,2} from the de-interleaved LLRs

$${l}_{c , 2}^{{π}_{2}^{- 1}} .$$

The channel output y is superposed by different modulated symbols of different users and the channel noise.

$${\hat{x}}_{c , 2}^{{π}_{2}}$$

(already provided by 662 and 663) is used by the LLR computation block 646 to re-construct the estimated modulated symbols from UE2, which is defined here as ŝ_{c,2}. As the next user in the channel decoding is UE3, the LLR computation block 646 removes the interference of UE2 from the received signal by computing (y−ŝ_{c,2}), which is then used to compute l_{c,3}. Note that only the interference of UE2 is removed from y while the interference of UE1 and UE4 are treated as noise for UE3. Channel decoder 664 then computes \hat{x}_{c,3} from the de-interleaved LLR values

$${l}_{c , 3}^{{π}_{3}^{- 1}} ,$$

followed by interleaving \hat{x}_{c,3} in block 665 to produce

$${\hat{x}}_{c , 3}^{{π}_{3}}$$

which is sent to the LLR computation block 646.

Similarly, for UE4, the next UE in the channel decoding queue, the LLR computation block 646 computes l_{c,4} from (y−ŝ_{c,2}−ŝ_{c,3}), note that \hat{x}_{c,3} is the estimate received symbols received from UE3, constructed from

$${\hat{x}}_{c , 3}^{{π}_{3}} .$$

Channel decoder 666 then computes \hat{x}_{c,4} from

$${l}_{c , 4}^{{π}_{4}^{- 1}} .$$

Interleaver 667 interleaves \hat{x}_{c,4} to produce

$${\hat{x}}_{c , 4}^{{π}_{4}}$$

and sends it to the LLR computation block 646.

Finally, for UE1, the LLR computation block 646 constructs the estimate symbols ŝ_{c,4} from

$${\hat{x}}_{c , 4}^{{π}_{4}} ,$$

followed by computing (y−_{c,2}−ŝ_{c,3}−ŝ_{c,4}) and uses it to compute l_{c,1}. \hat{x}_{c,1} is then obtained from channel decoder 660 using

$${l}_{c , 1}^{{π}_{1}} .$$

Interleaver 661 interleaves \hat{x}_{c,1} to produce

$${\hat{x}}_{c , 1}^{{π}_{1}}$$

and sends it to the LLR computation block 646.

In the second (last) iteration, parallel inference cancellation is used. In this iteration, as all the estimated received symbols of all the users, ŝ_{c,i}, 1≤i≤4, are obtained from the first iteration, perform parallel inference cancellation for all the users to improve the reliability of l_{c,i}. Specifically, for each user i-th, 1≤i≤4, the LLR computation block 646 computes l_{c,i} from the inference-cancelled signal

$$( y - {\sum }_{j = 1 , j \neq i}^{4} {\hat{s}}_{c , j} ) .$$

Each channel decoder then estimates its uncoded bits using the updated and interleaved LLR values

$${l}_{c , i}^{{π}_{i}} .$$

Specifically, the uncoded bits are \hat{x}_{s,1} for UE1, while those for UE2, UE3, and UE4 are \hat{m}₂, \hat{m}₃, and \hat{m}₄, respectively.

Note that using 2 iterations for the Turbo channel receiver significantly improves the decoding error probability when compared with the case when only 1 iteration is used. It is also observed that using more than 2 iterations for the Turbo channel receiver only minimally improves the channel decoding error probabilities, while considerably increases the computational complexity.

However, it should be understood the described embodiments are not limited to 2 iterations of Turbo channel decoding, and other receiver models can be used.

### DCI Package Formation

In some embodiments, DCI is used to set up the transmission from correlated UEs. The content may be different for power-domain NOMA as opposed to code-domain NOMA.

### Power-Domain NOMA

In implementations featuring power-domain NOMA, signaling information to be sent to the UEs includes a group identifier (ID) that is associated with each group of correlated UEs, the new payload sizes, and the power scale parameters

$${a}_{i}^{′} .$$

This information can be sent to the set of the correlated users in the form of a DCI package. It is worth noting that in many practical applications where the UEs are stationary, e.g., as in the dense camera sensor network example, the user grouping does need to not occur often since the data correlation among the UEs is relatively static. Thus, the signaling overhead required by the proposed rate allocation scheme is not significant.

Before each uplink communication session of the targeted UEs in a group, the adjusted power scale parameter β is broadcasted to the UEs and only the UEs with the targeted Group ID need to update β. This broadcasting session significantly reduces the signaling overhead especially when the number of users is large. For example, in a first DCI,

$${a}_{i}^{′}$$

parameters are unicasted to each UE. At the subsequent DCIs, only the new value of β is broadcast to all the UEs, while

$${a}_{i}^{′}$$

remain unchanged. Each UE then computes its

$${a}_{i}^{′}$$

as shown in the equation presented previously, using the fixed power-scale

$${a}_{i}^{′}$$

and the broadcasted power scale β. This computation can occur at Block 614 of FIG. 6A.

### Code-Domain NOMA

In implementations featuring code-domain NOMA, signaling information to be sent to the UEs includes the Group ID and the new payload sizes. This is sent to the correlated users prior to an uplink communication session for a targeted group of UEs.

### Rate Allocation and Source Coding Scheduling

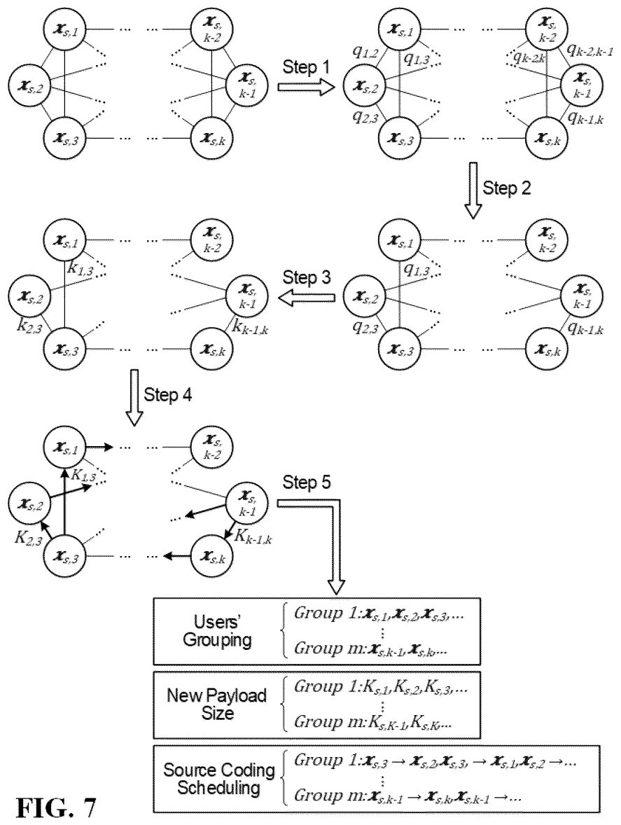

FIG. 7 shows another view of a method of rate allocation and source coding scheduling. Given a number of UEs, the operations required by the BS to determine the users' correlations and allocate the code rates based on the learned correlations are given as follows:

Step 1: Obtain the pair-wise correlation parameters for all the UEs, then form a fully connected graph of all the users. The nodes of the graph correspond to the UEs. Each edge of the graph corresponds to a correlation parameter q_{i,j} of the UEs with indices i and j. In this step, existing knowledge of the UEs obtained from the previous communication sessions and/or another method, e.g., correlation information obtained during the deployment of the UEs, may be used to learn the correlations among the UEs.

Step 2: Prune the edges where the correlation parameters q_{i,j}≥0.5−Δ, ∀i,j,0≤Δ<<0.5, and Δ is a tunable threshold. Intuitively, if q_{i,j}≥0.5−Δ, the correlations between the UEs with indices i and j are relatively small, thus the edge associated with q_{i,j} can be pruned to reduce the space complexity of the graph.

Step 3: Use the correlation parameters to compute the initial correlated payload sizes associated with all the remaining edges. The correlation parameter q_{i,j} can be used to compute to payload size of the UEs pair with indices i and according to: K_{i,j}=K_{j,i}=min{αNₛH(q_{i,j}), Nₛ}, where H(q_{i,j})=−q_{i,j} log₂ q_{i,j}−(1−q_{i,j})log₂(1−q_{i,j}) is the binary cross entropy function and α, α≥1, is a scaling factor. The role of α is to compensate for the non-optimal estimate of K_{i,j} using NₛH(q_{i,j}), especially when the binary sources are of short to moderate length.

Step 4: Apply a graph traversal that visits all the graph nodes while trying to obtain the smallest sum of the payload sizes K_{i,j}. This is because if the number of the UEs is large, it is practically impossible to compute the optimal traversal. However, heuristic graph search algorithms with feasible computational complexity and latency are known to produce near-optimal traversals.

Step 5: Output Group IDs and the user IDs in each group, the new payload sizes and the source decoding order of the UEs in each group. The outputs of the rate allocation and source coding order will be used to determine the channel decoding order and other related parameters for the channel decoding process used by any uplink NOMA schemes. Thus, this approach can be directly applied to existing uplink NOMA frameworks.

### CRC Attachment and Verifications Schemes for Polar Source Coding

In some embodiments, polar coding is used as the source coding scheme. Polar source coding is used to compress the original payload x_{s,i} of the i-th UE. A CRC attachment scheme for source coding can be used to improve the source CA-SCL decoding performance at the BS.

The following steps describe are an example of a source CRC attachment process at the distributed UEs.

Step 1: Compute the CRC remainders of x_{s,i}, denoted as c_{s,i}. The CRC polynomials needed for the computations can, for example, be determined by an MCS table and the source length Nₛ, which is both known by the distributed UEs and the BS.

Step 2: The original payload x_{s,i} is polar source encoded (compressed), denoted as

$${x}_{s , i}^{( c )} .$$

### Then,

$${x}_{s , i}^{( c )}$$

and c_{s,i} are concatenated together to form the final payload

$${m}_{s , i} = [ {x}_{s , i}^{( c )} , {c}_{s , i} ] ,$$

used by the channel coding task.

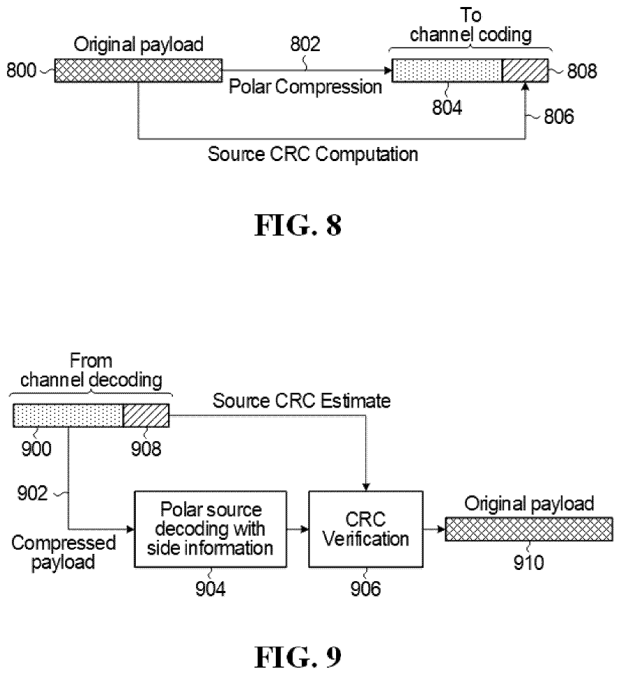

FIG. 8 is a block diagram of a source CRC attachment scheme. The original payload 800 is polar encoded at 802 to produce compressed payload 804. The CRC is computed at 806 and appended to the compressed payload 804 at 808.

Similarly, the reverse operations are executed at the BS to verify the CRC at the decoding process. The following steps describe the proposed CRC verification scheme.

Step 1: Detach the estimated compressed payload and the estimated CRC bits of the original payload.

Step 2: Given a list of the estimated original payloads outputted from the CA-SCL source decoder, compute the CRC bits for each of the original payload and compare them with the estimated CRC bits from the channel decoder. The CRC polynomials used at the BS are also selected from the MCS table given Nₛ, known by both the UEs and the BS.

Step: Select the estimated original payload that has the same CRC bits provided by the channel decoder.

FIG. 9 is a block diagram of a source CRC verification scheme. The output of channel decoding is indicated at 902 and includes an estimate of the compressed payload 900 and a source CRC estimate 908. The compressed payload is decoded at 904. CRC verification takes place at 906, comparing the estimated CRC with a computed CRC based on the received payload and the recovered payload is output at 910.

### Implementation of the Signalling Process

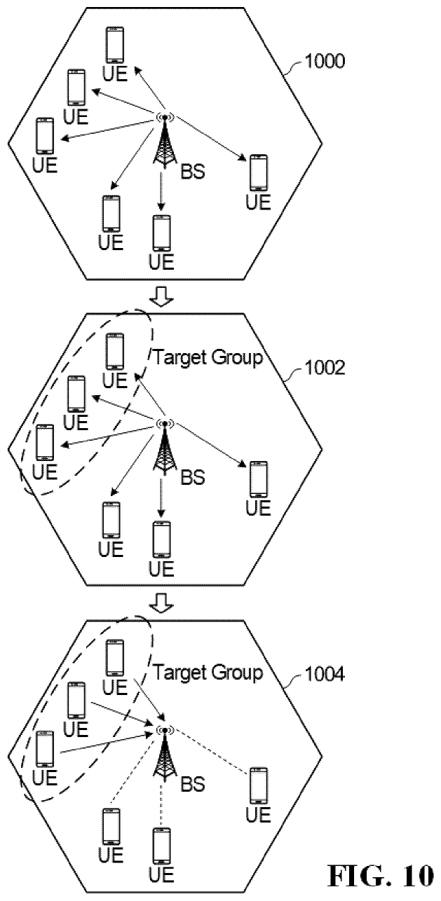

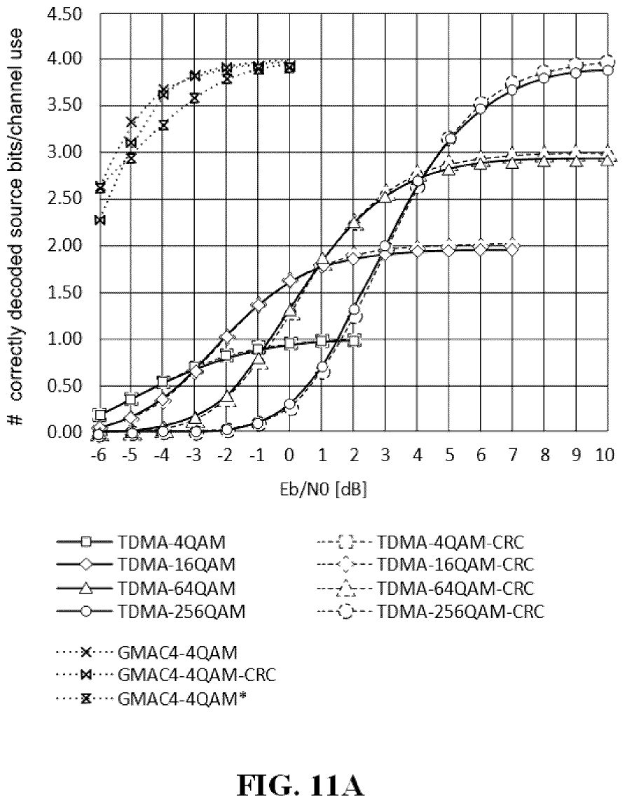

To configure the uplink session between the UEs and the BS, the configurations for users' grouping, rate allocation, and power control is sent from the BS to the UEs prior to the uplink communication. In some embodiments, this is achieved through the use of two downlink communication sessions, with the downlink sessions containing the DCI packages enclosing the configurations. This is depicted in FIG. 10.

In the first DCI session generally indicated at 1000, the BS sends to each UE the group number, the payload size, and the initial power scale aᵢ associated with that UE if power-domain NOMA is used, for code-domain NOMA, the parameters aᵢ are omitted. In a case where the UEs are stationary UEs, whose correlations are relatively static, the first DCI session does not occur frequently, resulting in low overhead and improved practicality. The first DCI session may take place in the form of unicast transmissions from the BS to individual UEs as depicted in FIG. 10.

In the second DCI session, prior to any uplink communication from a group of targeted UEs to the BS, a DCI package is first broadcasted from the BS to all the UEs, as indicated generally at 1002 in FIG. 10. If power-domain NOMA is used, the DCI package contains the targeted group ID and the associated power scale β shared by all the UEs in the targeted UE group. On the other hand, if code-domain NOMA is used, the DCI package contains the targeted group ID and the adjusted payload sizes of all the UEs in the targeted group.

Also shown in FIG. 10, generally indicated at 1004, is the subsequent uplink data transmission from the UEs, based on the configurations transmitted at 1000 and 1002.

Performance gain may be realized due to the rate allocation scheme described above. In general, the data correlations existing among the UEs allow the payload sizes of the correlated UEs to be further compressed. The reduction in the payload sizes of the correlated UEs leaves more room for parameter optimization, for example for the channel coding task under NOMA schemes. This in turn enables a significant improvement in the system's performance.

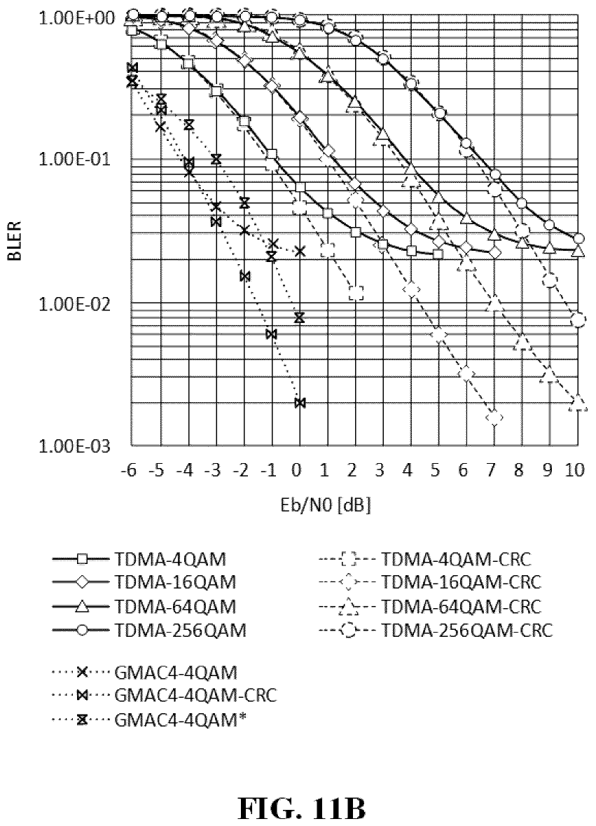

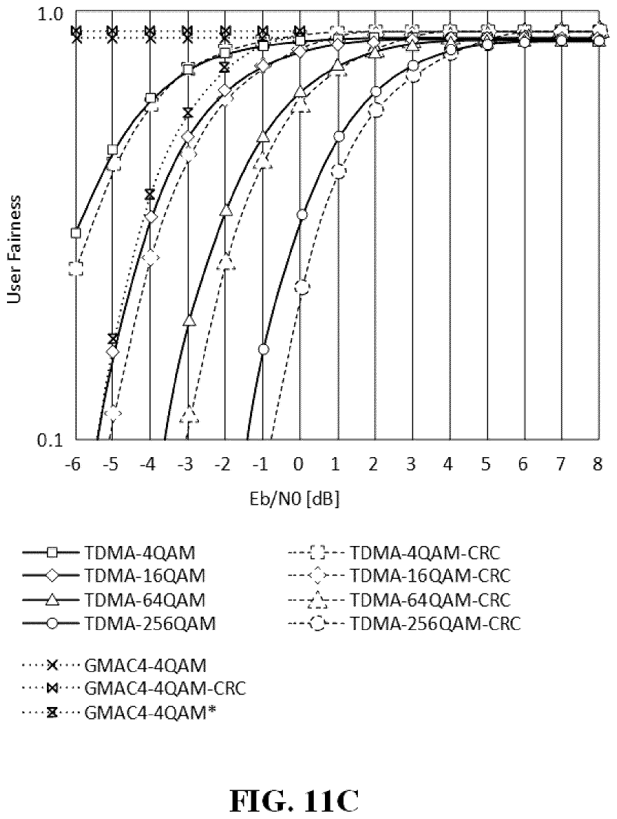

In FIGS. 11A,11B and 11C, numerical results are shown comparing performance of an example implementation of an embodiment of the disclosure for uplink communication against the OMA counterparts, denoted by the curves with the TDMA prefix with different modulation settings: 4QAM, 16QAM, 64QAM, and 256QAM. In summary, the block error rate (BLER) of the provided scheme, denoted as Gaussian Multiple Access (GMAC) GMAC4-4QAM-CRC, is significantly better than that of all the other schemes. The curves are referred to as GMAC in the figures as a Gaussian channel is assumed, but this need not be the case more generally. Furthermore, the provided scheme also performs best in terms of spectrum efficiency (number of correctly decoded source bits/channel use) and user fairness.

Numerous modifications and variations of the present disclosure are possible in light of the above teachings. It is therefore to be understood that within the scope of the appended claims, the disclosure may be practiced otherwise than as specifically described herein.

The provided approaches are applicable to a wide range of applications and is greatly suitable for dense sensor networks, in which the UEs are stationary and are deployed close to each other, e.g., fixed camera or fixed environmental sensor arrays. The majority of the provided technical solutions are implemented at the BS side with minimal changes required at the UEs. The distributed UEs implement additional steps for source encoding and CRC attachment in addition to the existing channel coding and CRC attachment schemes. However, the additional steps occurred at the UEs are of low complexity.

The techniques provided are general and can be applied to a wide range of sensor network applications. Existing NOMA schemes can directly utilize the rate allocation scheme presented to further improve their performance. In addition, the provided approaches can also be applied to Wi-Fi technologies, as long as there is a similar communication relation between the UEs and the BS, in which the correlations among the UEs are strong.

As noted above, in some embodiments, polar coding is used for both channel and source coding. Polar codes are already used in 5G for channel decoding. In some embodiments, the 5G polar codes are reused for the new distributed source coding task. this enables a straightforward integration of the provided approach into current standards. In addition, this approach also significantly reduces the encoding and decoding complexity at the UEs and the BS, respectively, as the polar encoder and decoder can be reused for both the channel and source codes.

However, other types of coding can be used. For example, low density parity check (LDPC), Turbo, or other linear error-correction codes can be used for the purpose of source coding. However, an advantage exists in using polar codes for both channel and source coding since in that case a single decoder can be used for both tasks, hence reducing implementation complexity (hardware resources). The provided CRC attachment scheme works best for polar codes, while negligible gains would be obtained for LDPC codes. This is due to the natural properties of the decoding algorithms used to decode LDPC and polar codes, which are different.

1. A method in an apparatus, the method comprising:
receiving signaling indicating a compressed payload size for use by the apparatus as part of a group of apparatuses having correlated data to transmit; and
transmitting a channel coded output, the channel coded output comprising an output of channel coding that has been applied to a payload and a concatenated cyclic redundancy check (CRC), the payload being source coded using a polar code based on the compressed payload size, and the concatenated CRC being computed from the payload.

2. The method of claim 1, the method further comprising:
receiving first signaling assigning a group ID to the apparatus, wherein the group ID is associated with the group of apparatuses with the correlated data to transmit;
receiving second signaling indicating an apparatus specific gain adjustment; and
receiving third signaling indicating a targeted group ID matching the group ID assigned to the apparatus, the third signaling further indicating a group specific gain adjustment that is specific to apparatuses having the targeted group ID,
wherein the transmitting the channel coded output comprises transmitting a power-domain non-orthogonal multiple access (NOMA) signal with a gain based on the apparatus specific gain adjustment, the group specific gain adjustment, and a channel estimate.

3. The method of claim 2, further comprising:
receiving a first downlink control information (DCI) package, the first DCI package being apparatus specific and comprising the signaling indicating the compressed payload size, the first signaling assigning the group ID to the apparatus, and the second signaling indicating the apparatus specific gain adjustment; and
receiving a second DCI package, the second DCI package being group specific and comprising the third signaling indicating the targeted group ID matching the group ID assigned to the apparatus.

4. The method of claim 1, wherein:
the transmitting the channel coded output comprises transmitting a code-domain NOMA signal, the method further comprising:
receiving first signaling assigning a group ID to the apparatus, wherein the group ID is associated with the group of apparatuses with the correlated data to transmit; and
receiving second signaling indicating a targeted group ID and indicating payload adjustments for all apparatuses having the targeted group ID.

5. The method of claim 4, further comprising:
receiving a first DCI package, the first DCI package being apparatus specific and comprising the signaling indicating the compressed payload size and the first signaling assigning the group ID to the apparatus; and
receiving a second DCI package, the second DCI package being group specific and comprising the second signaling indicating the targeted group ID matching the group ID assigned to the apparatus.

6. A method in an apparatus, the method comprising:
transmitting signaling indicating a compressed payload size for use by the apparatus as part of a group of apparatus having correlated data to transmit; and
receiving a channel coded output, the channel coded output comprising an output of channel coding that has been applied to a payload and a concatenated cyclic redundancy check (CRC), the payload being source coded using a polar code based on the compressed payload size, and the concatenated CRC being computed from the payload.

7. The method of claim 6, the method further comprising:
transmitting first signaling assigning a group ID to the apparatus, wherein the group ID is associated with the group of apparatuses with the correlated data to transmit;
transmitting second signaling indicating an apparatus specific gain adjustment; and
transmitting third signaling indicating a targeted group ID matching the group ID assigned to the apparatus, the third signaling further indicating a group specific gain adjustment that is specific to apparatuses having the targeted group ID,
wherein the receiving the channel coded output comprises receiving a power-domain non-orthogonal multiple access (NOMA) signal with a gain based on the apparatus specific gain adjustment, the group specific gain adjustment and a channel estimate.

8. The method of claim 7, further comprising:
transmitting a first DCI package, the first DCI package being apparatus specific and comprising the signaling indicating the compressed payload size, the first signaling assigning the group ID to the apparatus and the second signaling indicating the apparatus specific gain adjustment; and
transmitting a second DCI package, the second DCI package being group specific and comprising the third signaling indicating the targeted group ID matching the group ID assigned to the apparatus.

9. The method of claim 6, wherein:
the receiving the channel coded output comprises transmitting a code-domain NOMA signal, the method further comprising:
transmitting first signaling assigning a group ID to the apparatus, wherein the group ID is associated with the group of apparatuses with the correlated data to transmit; and
transmitting second signaling indicating a targeted group ID and indicating payload adjustments for all apparatuses having the targeted group ID.

10. The method of claim 9, further comprising:
transmitting a first DCI package, the first DCI package being apparatus specific and comprising the signaling indicating the compressed payload size and the first signaling assigning the group ID to the apparatus; and
transmitting a second DCI package, the second DCI package being group specific and comprising the second signaling indicating the targeted group ID matching the group ID assigned to the apparatus.

11. An apparatus comprising:
at least one processor; and
a memory storing instructions, which when executed by the at least one processor, cause the apparatus to perform:
receiving signaling indicating a compressed payload size for use by the apparatus as part of a group of apparatuses having correlated data to transmit; and
transmitting a channel coded output, the channel coded output comprising an output of channel coding that has been applied to a payload and a concatenated cyclic redundancy check (CRC), the payload being source coded using a polar code based on the compressed payload size, and the concatenated CRC being computed from the payload.

12. The apparatus of claim 11, the instructions, when executed by the at least one processor, further causing the apparatus to perform:
receiving first signaling assigning a group ID to the apparatus, wherein the group ID is associated with the group of apparatuses with the correlated data to transmit;
receiving second signaling indicating an apparatus specific gain adjustment; and
receiving third signaling indicating a targeted group ID matching the group ID assigned to the apparatus, the third signaling further indicating a group specific gain adjustment that is specific to apparatuses having the targeted group ID,
wherein the transmitting the channel coded output comprises transmitting a power-domain non-orthogonal multiple access (NOMA) signal with a gain based on the apparatus specific gain adjustment, the group specific gain adjustment and a channel estimate.

13. The apparatus of claim 12, the instructions, when executed by the at least one processor, further causing the apparatus to perform:
receiving a first DCI package, the first DCI package being apparatus specific and comprising the signaling indicating the compressed payload size, the first signaling assigning the group ID to the apparatus, and the second signaling indicating the apparatus specific gain adjustment; and
receiving a second DCI package, the second DCI package being group specific and comprising the third signaling indicating the targeted group ID matching the group ID assigned to the apparatus.

14. The apparatus of claim 11, wherein:
the transmitting the channel coded output comprises transmitting a code-domain NOMA signal, the instructions, when executed by the at least one processor, further causing the apparatus to perform:
receiving first signaling assigning a group ID to the apparatus, wherein the group ID is associated with the group of apparatuses with the correlated data to transmit; and
receiving second signaling indicating a targeted group ID and indicating payload adjustments for all apparatuses having the targeted group ID.

15. The apparatus of claim 14, the instructions, when executed by the at least one processor, further causing the apparatus to perform:
receiving a first DCI package, the first DCI package being apparatus specific and comprising the signaling indicating the compressed payload size and the first signaling assigning the group ID to the apparatus; and
receiving a second DCI package, the second DCI package being group specific and comprising the second signaling indicating the targeted group ID matching the group ID assigned to the apparatus.

16. An apparatus comprising:
at least one processor; and
a memory storing instructions, which when executed by the at least one processor, cause the apparatus to perform:
transmitting signaling indicating a compressed payload size for use by the apparatus as part of a group of apparatus having correlated data to transmit; and
receiving a channel coded output, the channel coded output comprising an output of channel coding that has been applied to a payload and a concatenated cyclic redundancy check (CRC), the payload being source coded using a polar code based on the compressed payload size, and the concatenated CRC being computed from the payload.

17. The apparatus of claim 16, the instructions, when executed by the at least one processor, further causing the apparatus to perform:
transmitting first signaling assigning a group ID to the apparatus, wherein the group ID is associated with the group of apparatuses with the correlated data to transmit;
transmitting second signaling indicating an apparatus specific gain adjustment; and
transmitting third signaling indicating a targeted group ID matching the group ID assigned to the apparatus, the third signaling further indicating a group specific gain adjustment that is specific to apparatuses having the targeted group ID,
wherein the receiving the channel coded output comprises receiving a power-domain non-orthogonal multiple access (NOMA) signal with a gain that is based on the apparatus specific gain adjustment, the group specific gain adjustment and a channel estimate.

18. The apparatus of claim 17, the instructions, when executed by the at least one processor, further causing the apparatus to perform:
transmitting a first DCI package, the first DCI package being apparatus specific and comprising the signaling indicating the compressed payload size, the first signaling assigning the group ID to the apparatus, and the second signaling indicating the apparatus specific gain adjustment; and
transmitting a second DCI package, the second DCI package being group specific and comprising the third signaling indicating the targeted group ID matching the group ID assigned to the apparatus.

19. The apparatus of claim 16, wherein:
the receiving the channel coded output comprises transmitting a code-domain NOMA signal, the instructions, when executed by the at least one processor, further causing the apparatus to perform:
transmitting first signaling assigning a group ID to the apparatus, wherein the group ID is associated with the group of apparatuses with the correlated data to transmit; and
transmitting second signaling indicating a targeted group ID and indicating payload adjustments for all apparatuses having the targeted group ID.

20. The apparatus of claim 19, the instructions, when executed by the at least one processor, further causing the apparatus to perform:
transmitting a first DCI package, the first DCI package being apparatus specific and comprising the signaling indicating the compressed payload size and the first signaling assigning the group ID to the apparatus; and
transmitting a second DCI package, the second DCI package being group specific and comprising the second signaling indicating the targeted group ID matching the group ID assigned to the apparatus.
